(19) United States
(12) Patent Application Publication
(10) Pub. No.: US 2008/0286717 A1
(43) Pub. Date: Nov. 20, 2008

(54) Dental impression tray with contoured occlusal surface

(76) Inventor: Mark Sherwood, Burlingame, CA (US)

Correspondence Address: ALIGN TECHNOLOGY C/O WAGNER BLECHER LLP, 123 WESTRIDGE DRIVE, WATSONVILLE, CA, 95076, US

(21) Appl. No.: 11/804,424

(22) Filed: May 18, 2007

(51) Int. Cl. A61C 9/00

(52) U.S. Cl. 433/47

(57) ABSTRACT

A dental impression tray. A trough is for receiving impression material used in forming a dental impression of a plurality of teeth. A contoured occlusal surface within the trough is for reducing potential surface area contact with a tooth of the plurality of teeth

### FIELD

Embodiments of the present invention relate in general to the field of dentistry.

### BACKGROUND

Many dental procedures, such as orthodontic treatments, require formation of models of a patient's teeth. For instance, orthodontic treatments involve repositioning misaligned teeth and improving bite configurations for improved cosmetic appearance and dental function. Typically, an impression of the patient's teeth is taken for purposes of forming the model.

Typically, an impression is taken by placing an impression material, such as alginate, in an impression tray. The filled impression tray is then placed in the patient's mouth around the patient's teeth, e.g., the upper teeth or lower teeth. The impression material is allowed to sufficiently harden around the patient's teeth, and is then removed. The hardened impression material including the impression is then used to form a model of the patient's teeth.

In order to form a model of a patient's teeth sufficient for use in certain dental procedures, it is necessary to take an impression of the teeth that satisfies certain tolerances. For instance, if the impression taker pushes the impression tray too much, the occlusal surface of the impression tray may make contact with the teeth before the impression material sets. This contact with the teeth often causes holes, also referred to as “show through” to form in the impression material. If the number and severity of the show through is too great and a sufficient model of the patient's teeth can not be made, the impression will have to be retaken. For example, certain orthodontic treatments require show through of not greater than one square millimeter.

Taking impressions of a patient's teeth requires time of both the impression taker and the patient. Moreover, impression material is typically meant for a single use. Retaking impressions where the initial impression is defective, e.g., has too much show through, requires additional cost in time of the patient and impression taker, as well as the cost of the materials. Furthermore, where the flawed impression is not detected until after the patient leaves the doctor's office, additional costs in patient and impression taker time are incurred to schedule another appointment.

### SUMMARY

Various embodiments of the present invention disclose a contoured dental impression tray. In accordance with one embodiment of the present invention, dental impression tray is described. A trough is for receiving impression material used in forming a dental impression of a plurality of teeth. A contoured occlusal surface within the trough is for reducing potential surface area contact with a tooth of the plurality of teeth.

### BRIEF DESCRIPTION OF THE DRAWINGS

FIG. 1 is an elevational diagram showing the anatomical relationship of the jaws of a patient upon which teeth may be moved by the method and apparatus of embodiments of the present invention.

FIG. 2 is a top-down view of a dental impression tray including a contoured occlusal surface, in accordance with one embodiment of the present invention.

FIG. 3 is a side view of dental impression tray including a contoured occlusal surface, in accordance with one embodiment of the present invention.

FIG. 4 is a view of a dental impression tray including a contoured occlusal surface, in accordance with one embodiment of the present invention.

FIG. 5 illustrates examples of positive contoured features, in accordance with embodiments of the present invention.

FIG. 6 is a flow chart illustrating an example method for fabricating a dental impression tray, in accordance with one embodiment of the present invention.

FIG. 7 is a flow chart illustrating an example method for reducing potential show through of a dental impression, in accordance with one embodiment of the present invention.

FIG. 8A is a top-down view of a dental impression tray including an anterior torque reducing handle, in accordance with a first embodiment of the present invention.

FIG. 8B is a side view of a dental impression tray including an anterior torque reducing handle, in accordance with a first embodiment of the present invention.

FIG. 9A is a top-down view of a dental impression tray including an anterior torque reducing handle, in accordance with a second embodiment of the present invention.

FIG. 9B is a side view of a dental impression tray including an anterior torque reducing handle, in accordance with a second embodiment of the present invention.

FIG. 10A is a top-down view of a dental impression tray including an anterior torque reducing handle, in accordance with a third embodiment of the present invention.

FIG. 10B is a side view of a dental impression tray including an anterior torque reducing handle, in accordance with a third embodiment of the present invention.

FIG. 11 is a flow chart illustrating an example method for fabricating a dental impression tray including an anterior torque reducing handle, in accordance with one embodiment of the present invention.

FIG. 12 is a flow chart illustrating an example method for reducing incisor distortion of a dental impression, in accordance with one embodiment of the present invention.

FIG. 13 is a top-down view of a dental impression tray including integrated instructional information, in accordance with an embodiment of the present invention.

The drawings referred to in this description should not be understood as being drawn to scale except if specifically noted.

### DESCRIPTION OF EMBODIMENTS

Reference will now be made in detail to various embodiments of the present invention, a dental impression tray, and methods for using and fabricating such a dental impression tray, examples of which are illustrated in the accompanying drawings. While the invention will be described in conjunction with the described embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the described embodiments of the present invention. However, it will be recognized by one of ordinary skill in the art that embodiments of the present invention may be practiced without these specific details. In other instances, well known methods, procedures, and components have not been described in detail as not to unnecessarily obscure aspects of the present invention.

Accordingly, various embodiments of the present invention disclose a dental impression tray including a contoured occlusal surface. As a result, embodiments of the present invention disclose a dental impression tray that reduces potential surface area contact between a tooth and the contoured occlusal surface. By reducing the potential surface area with which a tooth may contact the contoured occlusal surface, the potential for “show through” in the finished impression is reduced.

### System and Method for Positioning Teeth

Orthodontic treatments involve repositioning misaligned teeth and improving bite configurations for improved cosmetic appearance and dental function. Repositioning is accomplished by applying gentle controlled forces to a patient's teeth over an extended period of time. Due to the limited space within the oral cavity and extensive movements that some teeth must undergo, the teeth will often be moved throughout a series of intermediate patterns to properly arrange the teeth. For example, molars may be temporarily moved backwards (distalized) to create adequate space for movement of the incisors. Thus, a single patient may experience an average of 25-30 stages or alignment patterns before achieving the final desired teeth arrangement.

Conventionally, repositioning of teeth has been accomplished by what are commonly referred to as “braces.” Braces comprise a variety of appliances such as brackets, bands, archwires, ligatures, and O-rings. After the brackets are bonded to the teeth, periodic meetings with the orthodontist are required to allow the orthodontist to review how their last adjustment to the braces moved the teeth. These reactive adjustments involve bending the existing archwires that stretch between brackets or installing different archwires to induce different force properties on the teeth. In turn, the orthodontist may reactively adjust the braces by applying, replacing or tightening existing ligatures coupled between the brackets. In some treatment plans, the patient may be required to wear supplementary appliances, such as elastic bands or headgear, to supply additional or extraoral forces. Although conventional braces are effective, their use is often a tedious and time consuming process and requires many visits to the orthodontist's office. Moreover, from the patient's perspective, the use of braces is unsightly, uncomfortable, presents a risk of infection, and makes brushing, flossing, arid other dental hygiene procedures difficult.

In embodiments of the present invention, repositioning of teeth may be accomplished with the use of a series of removable elastic positioning appliances, referred to as “aligners”. Such appliances comprise a thin shell of elastic polymeric material that generally conforms to a patient's teeth but is slightly out of alignment with an initial or immediately prior tooth configuration. Placement of the elastic aligner over the teeth applies controlled forces in specific locations to gradually move the teeth into the new configuration. Repetition of this process with successive aligners comprising new configurations eventually move the teeth through a series of intermediate arrangements to a final desired arrangement. Conveniently and advantageously, the appliances are not affixed and the patient may place and replace the appliances at any time during the alignment process.

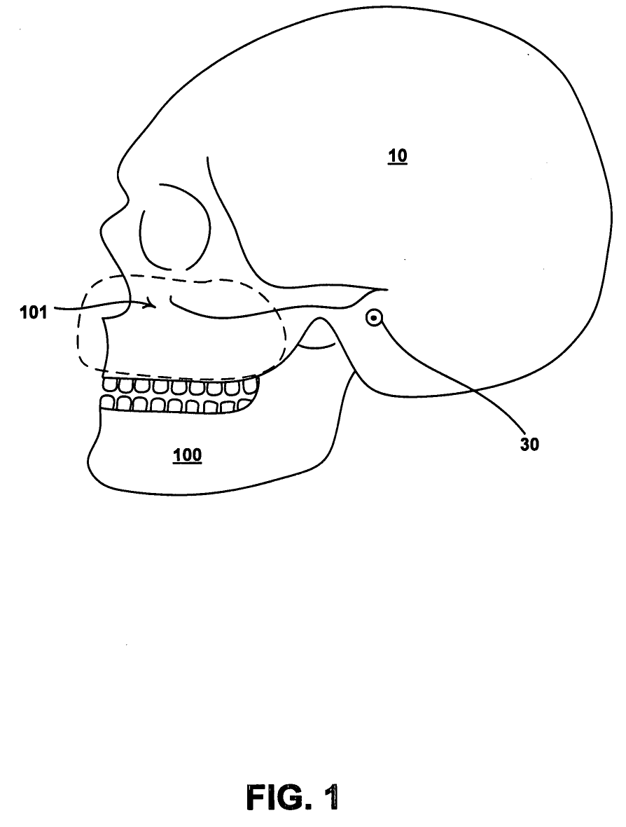

FIG. 1 is an illustration of a skull 10, upon which the repositioning of teeth is accomplished with a series of removable aligners, in accordance with one embodiment of the present invention. The skull 10 includes a maxilla or upper jaw 101 outlined approximately by the dotted circle. A set of upper teeth is associated with the upper jaw 101. The skull 10 also includes a mandible or lower jaw 100. A set of lower teeth is associated with lower jaw 100. Lower jaw 100 hinges at a joint 30 to skull 10. Joint 30 is called a temporomandibular joint (TMJ).

In one embodiment, a computer model of jaws 100 and 101 is generated. A computer simulation is capable of modeling interactions among the teeth on jaws 100 and 101. The computer simulation allows the system to focus on motions involving contacts between teeth mounted on the jaws. The computer simulation allows the system to render realistic jaw movements which are physically correct when jaws 100 and 101 contact each other. The modeling of jaws 100 and 101 places the individual teeth in a treated position.

Further, the model can be used to simulate jaw movements including protrusive motions, lateral motions, and “tooth guided” motions where the path of lower jaw 100 is guided by teeth contacts rather than by anatomical limits of jaws 100 and 101. Motions are applied to one jaw, but may also be applied to both jaws. Based on the occlusion determination, the final arrangement of the teeth in jaws 100 and 101 can be ascertained.

As a result, an initial digital data set (IDDS) representing an initial tooth arrangement and a final digital data set (FDDS) representing a final tooth arrangement are generated. Based on both the IDDS and the FDDS, a plurality of intermediate digital data sets (INTDDSs) are defined to correspond to incrementally adjusted aligners. The INTDDSs are defined using techniques for aligning teeth (e.g., the standard arch method, etc.). Thereafter, a set of incremental position adjustment aligners are produced based on the INTDDs and the FDDS. The aligners are designed to be worn over the teeth and to reposition the teeth to each of the tooth arrangements. The planning and fabrication of such aligners as an example elastic polymeric positioning appliance is described in detail in U.S. Pat. No. 5,975,893, and in published PCT application WO 98/58596 which designates the United States and which is assigned to the assignee of the present application.

In order to achieve the desired incremental repositioning, the impression of the teeth should be as accurate as possible. For instance, the position and dimensions of the teeth should be accurately and precisely captured. The greater the disparity between the actual position of the teeth and the impression of the teeth, and thus the model of the teeth used in designing the repositioning operations, the less accurate the resulting teeth movement will be. In order to provide the most accurate repositioning treatment, the the impression should be as accurate as possible.

Dental Impression Tray with Contoured Occlusal Surface

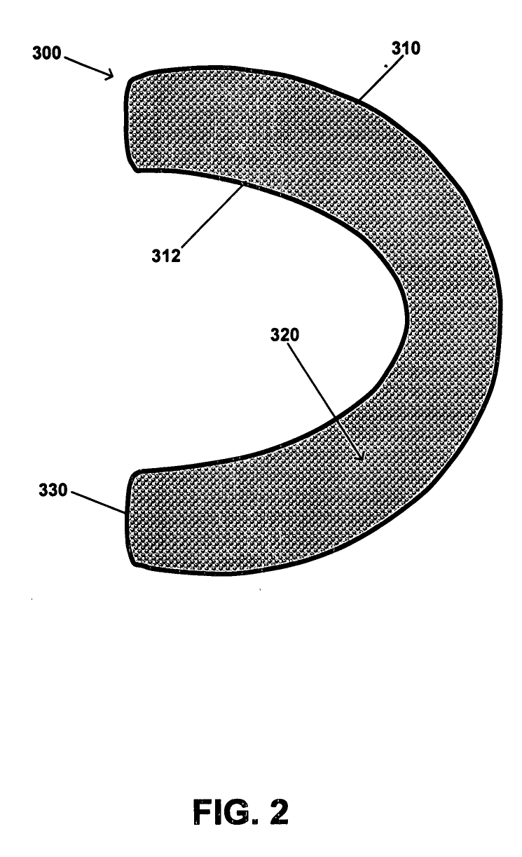

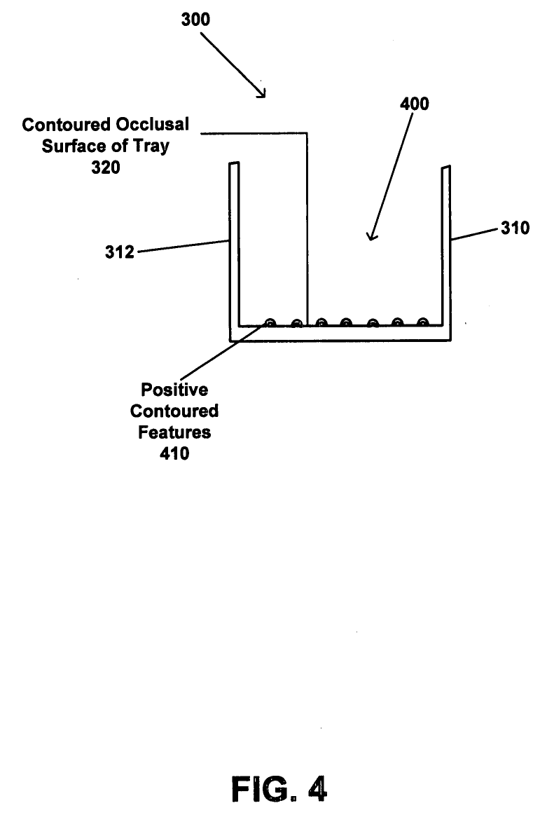

FIGS. 2, 3 and 4 illustrate different views of a dental impression tray 300, in accordance with embodiments of the present invention. Dental impression tray 300 includes contoured occlusal surface 320 is shown. Dental impression tray 300 includes outer wall 310, inner wall 312, contoured occlusal surface 320, and open rear edge 330. Outer wall 310, inner wall 312 and contoured occlusal surface 320 are formed to create a trough for receiving impression material used in forming a dental impression of a plurality of teeth, e.g., trough 400 of FIG. 4. It should be appreciated that dental impression tray 300 can receive any type of dental impression material, such as alginate for use in making dental impressions. Moreover, it should be appreciated that dental impression tray 300 can also receive other types of treatment materials used in dental procedures, including without limitation fluoride treatment and gingivitis treatment.

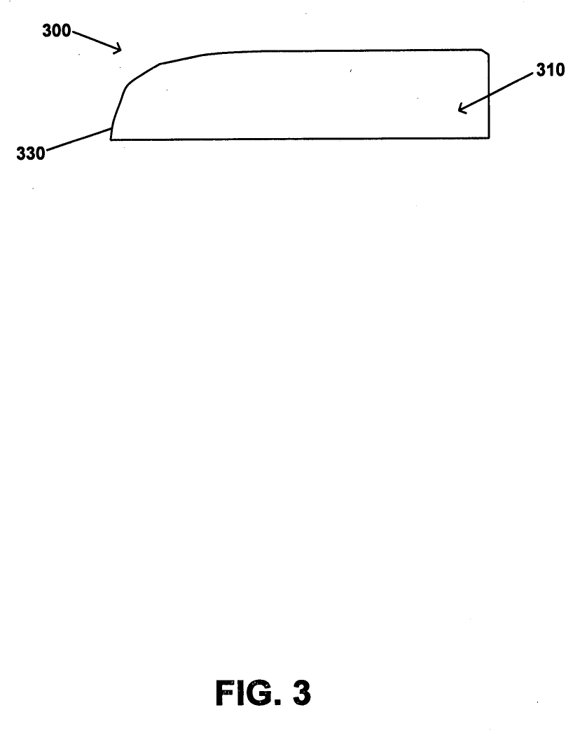

FIG. 3 is a side view of dental impression tray 300 including a contoured occlusal surface. As shown in FIG. 3, outer wall 310 meets open rear edge 330. Inner wall 312 also meets open rear edge (not shown). Open rear edge 330 is open to facilitate easy placement and removal of dental impression tray 300 over a patient's dentition. In the present embodiment, the impression material used in forming a dental impression is of sufficient thickness and viscosity to remain within the trough.

With reference to FIG. 2, contoured occlusal surface 320 is the surface of dental impression tray 300 that faces the occlusal surface of the patient's teeth upon placement over the dentition. The term occlusal refers to the biting and chewing surface of the patient's teeth. Contoured occlusal surface 320 is formed for reducing potential surface area contact with a tooth of the patient's dentition.

“Show through” refers to a hole formed in the impression material caused by a tooth contacting the occlusal surface of a dental impression tray while making an impression of the tooth. By contacting the occlusal surface, impression material is not able to adequately capture the tooth anatomy, primarily because the impression material is spread too thin by the tooth contacting the occlusal surface of the dental tray. Embodiments of the present invention provide a dental impression tray including a contoured occlusal surface for reducing potential surface area contact between the teeth and the occlusal surface.

FIG. 4 is a cut-away view of dental impression tray 300 including contoured occlusal surface 320, in accordance with one embodiment of the present invention. FIG. 4 shows trough 400 formed by outer wall 310, inner wall 312 and contoured occlusal surface 320. It should be appreciated that FIG. 4 is not drawn to scale, and is shown for illustrative purposes.

Dental impression tray 300 includes a plurality of positive contoured features 410. In one embodiment, the positive contoured features 410 protrude upward from contoured occlusal surface 320 and into trough 400. It should be appreciated that positive contoured features 410 reduce the potential surface area contact between teeth and the occlusal surface of dental impression tray 300.

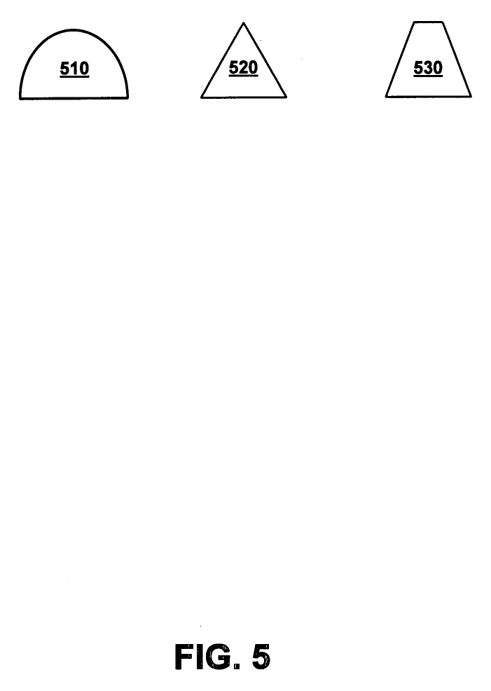

FIG. 5 illustrates examples of positive contoured features, in accordance with embodiments of the present invention. In one embodiment, the positive contoured features include substantially hemispherical bumps 510 protruding upward from contoured occlusal surface and into trough. In another embodiment the positive contoured features include substantially conical bumps 520. In another embodiment, the positive contoured features include substantially trapezoidal bumps 530. In the present embodiment, it should be appreciated that the top flat surface or trapezoidal bumps 530 is smaller than a predetermined show through threshold. In one embodiment, the predetermined show through threshold is one square millimeter. Accordingly, in the present embodiment, the surface area of top flat surface of trapezoidal bump 530 is less than one square millimeter.

It should be appreciated that the positive contoured features can include other shapes, including without limitation: dimples, pyramidal bumps, elliptical bumps, as well as other geometric shapes. Moreover, it should be appreciated that in various embodiments the positive contoured features extend upward from the occlusal surface at an angle of less than ninety degrees so as to limit the potential for air bubbles in the impression material. Positive contouring refers to contouring upwards into the trough of dental impression tray 300. In contrast, negative contouring refers to voids within a dental impression tray, e.g., holes, openings or gaps. The positive contouring reduces the potential surface area contact such that any contact between a tooth and the occlusal surface is limited to substantially a single point contact.

With reference to FIGS. 2 and 4, the plurality of positive contoured features 410 are arranged in a pattern on the contoured occlusal surface 320 for reducing potential surface area contact with a tooth of the plurality of teeth. In this embodiment, the positive contoured features 410 are arranged such that potential show through of a tooth of the plurality of teeth through the impression material is less than a predetermined show through threshold. The predetermined show through threshold is not greater than one square millimeter.

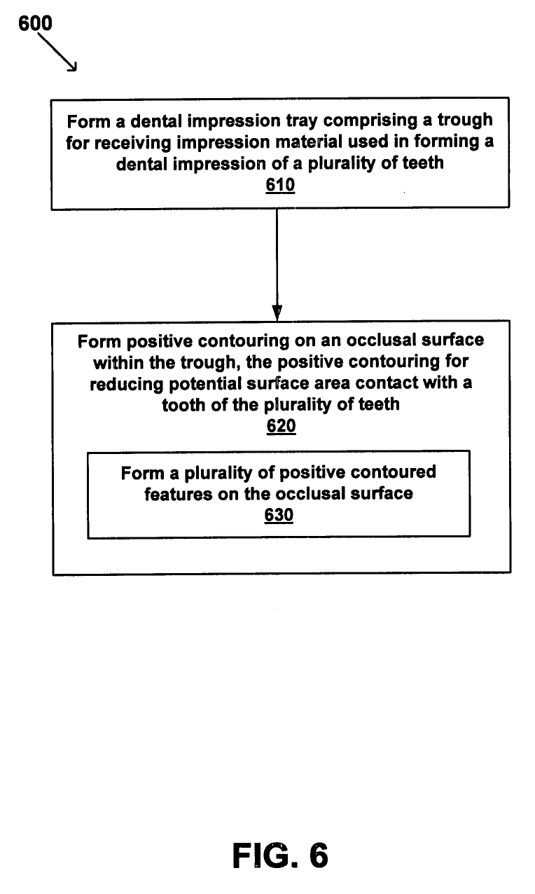

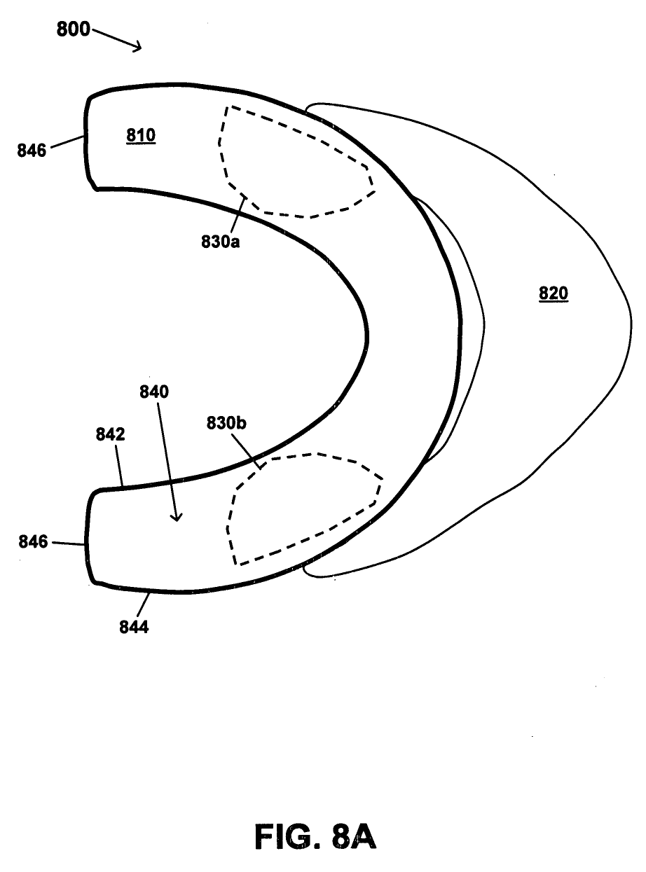

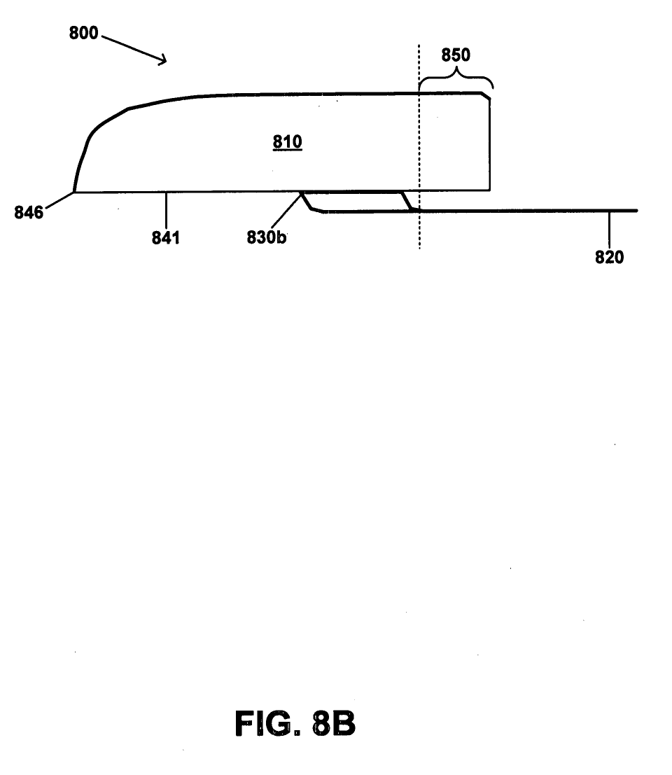

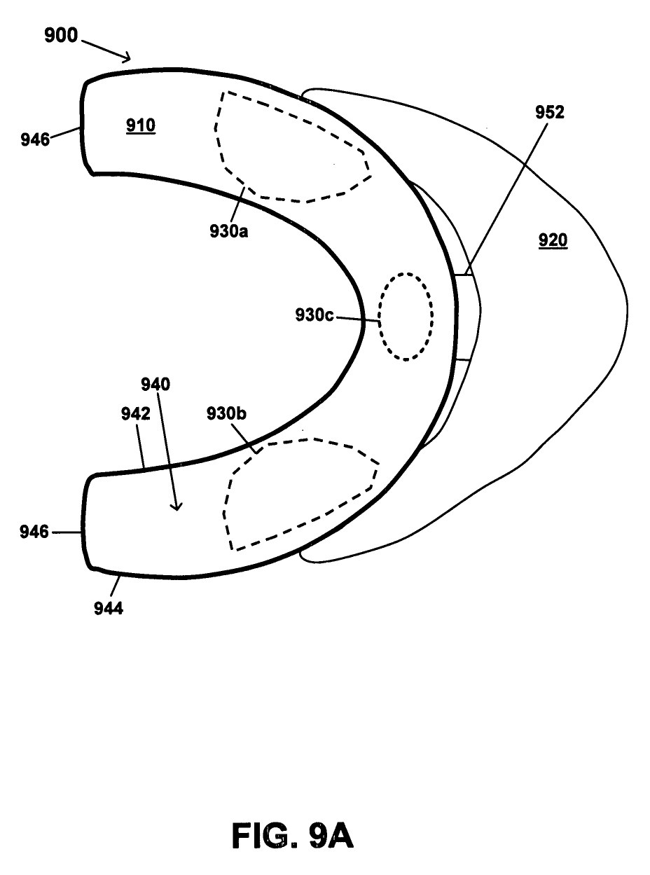

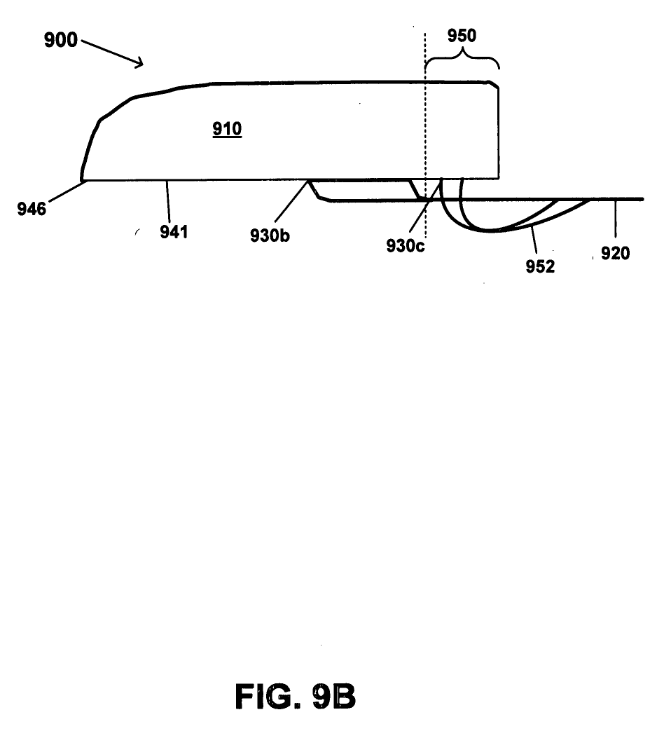

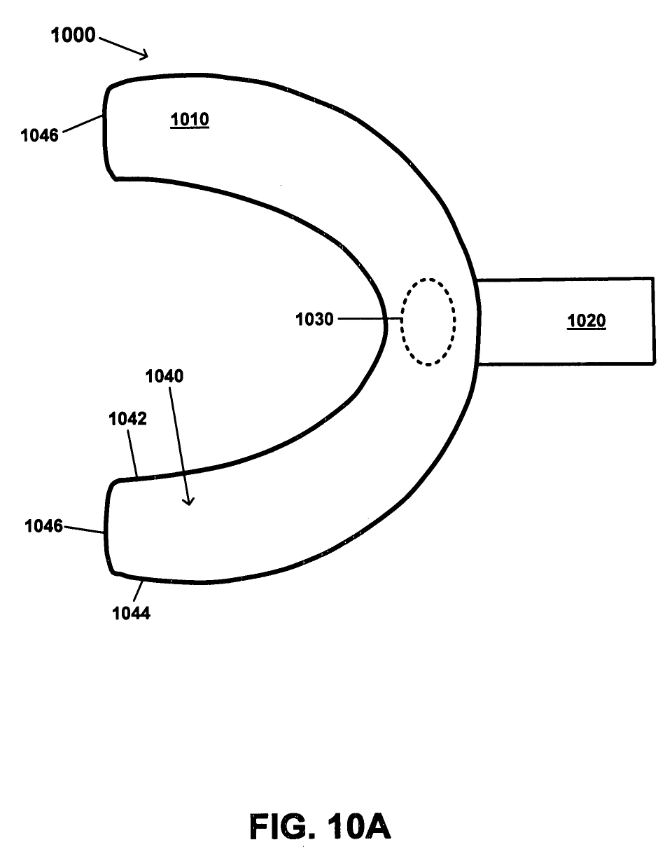

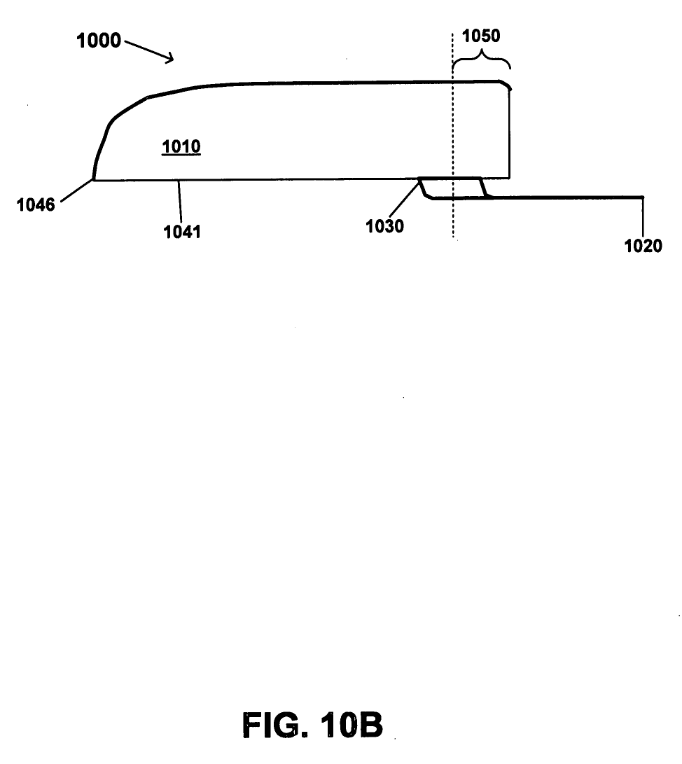

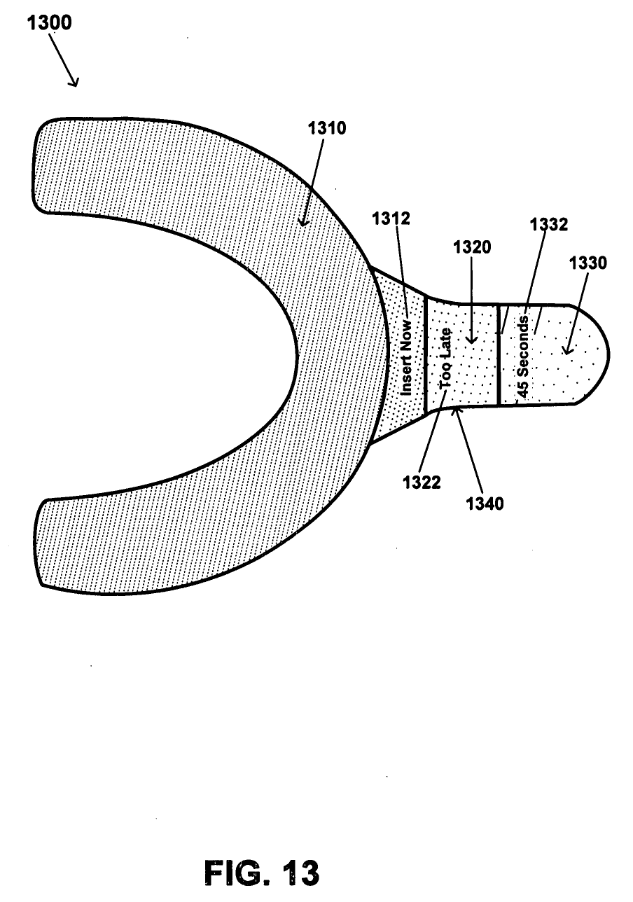

FIG. 6 is a flow chart illustrating an example process 600 for fabricating a dental impression tray, in accordance with one embodiment of the present invention. Process 600 is carried out by an impression tray fabrication system. For purposes of clarity and brevity, process 600 is described with reference to dental impression tray of FIGS. 2, 3 and 4. However, it should be appreciated that process 600 may be more generally applied to other dental impression trays, such as dental impression tray 800 of FIGS. 8A and 8B, dental impression tray 900 of FIGS. 9A and 9B, dental impression tray 1000 of FIGS. 10A and 10B, and dental impression tray 1300 of FIG. 13.

At step 610 of process 600, a dental impression tray 300 is formed to include a trough 400 for receiving impression material used in forming a dental impression of a plurality of teeth. In one embodiment, the dental impression tray is formed from plastic or other polymer. The dental impression tray could also be formed from a metallic substance.

At step 620, positive contouring on an occlusal surface 320 within the trough is formed, which reduces potential surface area contact with a tooth of the plurality of teeth. It should be appreciated that 610 and 620 can be performed in serial, in parallel, or any combination thereof. In one embodiment, forming the positive contouring of 620 includes forming a plurality of positive contoured features 410 on the occlusal surface, as shown at step 630. In FIG. 4, the positive contoured features 410 include substantially hemispherical bumps protruding upward from contoured occlusal surface 320 and into trough 400.

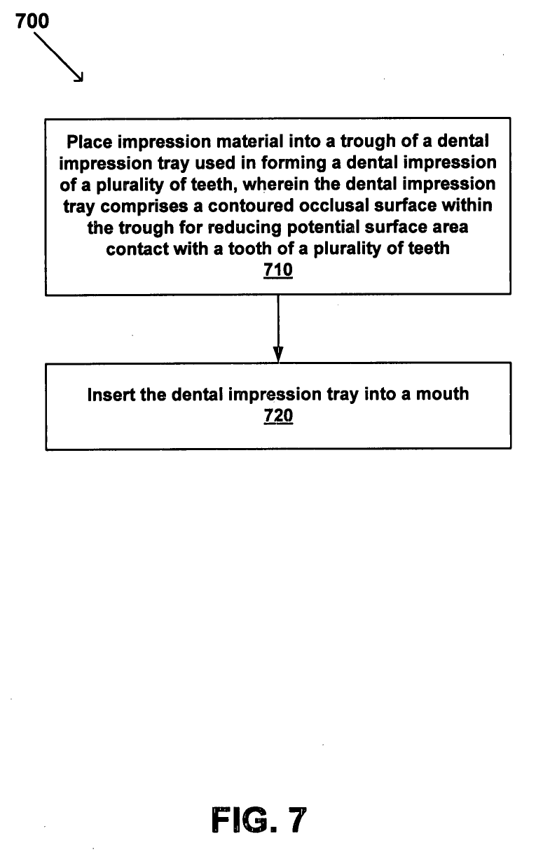

FIG. 7 is a flow chart illustrating an example method 700 for reducing potential show through of a dental impression, in accordance with one embodiment of the present invention. Process 700 is carried out by an impression taker, such as a dentist, orthodontist or other dental professional. For purposes of clarity and brevity, process 700 is described with reference to dental impression tray of FIGS. 2, 3 and 4. However, it should be appreciated that process 700 may be more generally applied to other dental impression trays, such as dental impression tray 800 of FIGS. 8A and 8B, dental impression tray 900 of FIGS. 9A and 9B, dental impression tray 1000 of FIGS. 10A and 10B, and dental impression tray 1300 of FIG. 13.

At step 710, impression material is placed into trough 400 of dental impression tray 300 used in forming a dental impression of a plurality of teeth, in which dental impression tray 300 includes a contoured occlusal surface 320 within trough 400 for reducing potential surface area contact with a tooth of a patient's dentition. At step 720, the dental impression tray is placed into a patient's mouth.

Accordingly, various embodiments of the present invention disclose a dental impression tray including a contoured occlusal surface. As a result, embodiments of the present invention provide a dental impression tray for reducing the number and severity of show through in dental impressions. The reduction in show through improves the quality of the dental impression, thereby improving the quality and usability of the resulting mold of the patient's dentition.

While the methods of embodiments illustrated in processes 600 and 700 show specific sequences and quantity of steps, the present invention is suitable to alternative embodiments. For example, embodiments of the present invention do not require all the steps provided for in the processes. Furthermore, additional steps can be added to the steps presented in the described embodiments. Likewise, the sequences of steps can be modified depending upon the application.

Dental Impression Tray with Anterior Torque Reducing Handle

Improper removal of a dental impression tray with hardened impression material may cause impression material distortion forces to distort the impression material. For instance, it is hypothesized that in some situations anterior thinning is created as a result of separation of impression material from the dental impression tray due to forces caused by removal of the dental impression tray using a conventional handle. A conventional handle is connected to the anterior portion of the dental impression tray, typically at the intersection of the outer wall and the occlusal surface. Anterior thinning refers to the effect of thinning teeth in the anterior region of the impression tray, e.g., thinning of the incisors, in the finished model of teeth created from the impression. Embodiments of the present invention provide a dental impression tray including an anterior torque reducing handle for reducing anterior thinning.

FIG. 8A is a top-down view of a dental impression tray 800 including an anterior torque reducing handle 820, in accordance with a first embodiment of the present invention. Dental impression tray 800 includes material receiving portion 810 including a trough configured to receive impression material used in forming a dental impression of a plurality of teeth. Material receiving portion 810 includes outer wall 844, inner wall 842, occlusal surface 840, and open rear edge 846. Outer wall 844, inner wall 842 and contoured occlusal surface 840 are formed to create the trough for receiving impression used in forming a dental impression of a plurality of teeth, e.g., trough 400 of FIG. 4. It should be appreciated that dental impression tray 800 can receive any type of dental impression material, such as alginate for use in making dental impressions. Moreover, it should be appreciated that dental impression tray 800 can also receive other types of treatment materials used in dental procedures, including without limitation fluoride treatment and gingivitis treatment.

Anterior torque reducing handle 820 is configured for distributing impression material distortion forces away from an anterior portion of dental impression tray 800 upon removal of dental impression tray 800 and at least partially solidified impression material from a plurality of teeth. Handle 820 is coupled to the underside of occlusal surface 840, illustrated in FIG. 8B as outer occlusal surface 841. For purposes of clarity and brevity, outer occlusal surface 841 is opposite the trough and referred to herein as the underside of occlusal surface 840. However, it should be appreciated that the term underside is not meant to limit the locations at which handle 820 is coupled to material receiving portion 810.

Connections 830a and 830b illustrate locations at which handle 820 is coupled to the underside of occlusal surface 840. Connections 830a and 830b are shown as dotted lines as they represent a hidden view of locations at which handle 820 is connected to receiving material portion 810. Handle 820 is coupled to the underside of occlusal surface 840 such that handle 820 is not coupled to a wall, e.g., inner wall 842 or outer wall 844, of material receiving portion 810. In one embodiment, handle 820 is coupled to the underside of occlusal surface 840 proximate locations where bicuspid teeth are received into material receiving portion 810. In another embodiment, handle 820 is coupled to the underside of occlusal surface 840 proximate locations where cuspid teeth are received into material receiving portion 810.

As shown in FIG. 8B, handle 820 is coupled to material receiving portion 810 such that impression material distortion forces are distributed away from anterior portion 850 of dental impression tray 800 upon removal of dental impression tray 800 and at least partially solidified impression material from a plurality of teeth. It should be appreciated that anterior portion 850 is an example anterior portion, and is shown as a dotted line indicating a general area from which impression material distortion forces are directed from.

FIG. 9A is a top-down view of a dental impression tray 900 including an anterior torque reducing handle 920, in accordance with a second embodiment of the present invention. Dental impression tray 900 includes material receiving portion 910 including a trough configured to receive impression material used in forming a dental impression of a plurality of teeth. Impression material receiving portion includes outer wall 944, inner wall 942, occlusal surface 940, and open rear edge 946. Outer wall 944, inner wall 942 and contoured occlusal surface 940 are formed to create the trough for receiving impression used in forming a dental impression of a plurality of teeth, e.g., trough 400 of FIG. 4. It should be appreciated that dental impression tray 900 can receive any type of dental impression material, such as alginate for use in making dental impressions, and other types of treatment materials used in dental procedures, including without limitation fluoride treatment and gingivitis treatment.

Dental impression tray 900 also includes an anterior torque reducing handle 920 coupled to material receiving portion 910. Anterior torque reducing handle 920 is configured for distributing impression material distortion forces away from an anterior portion of dental impression tray 900 upon removal of dental impression tray 900 and at least partially solidified impression material from a plurality of teeth. Handle 920 is coupled to the underside of occlusal surface 940 of material receiving portion 910 opposite the trough, illustrated in FIG. 9B as outer occlusal surface 941.

Connections 930a, 930b and 930c illustrate locations at which handle 920 is coupled to the underside of occlusal surface 940. Connections 930a, 930b and 930c are shown as dotted lines as they represent a hidden view of locations at which handle 920 is connected to impression receiving material portion 910. Handle 920 is coupled to the underside of occlusal surface 940 such that handle 920 is not coupled to a wall, e.g., inner wall 942 or outer wall 944, of material receiving portion 910. In one embodiment, handle 920 is coupled to the underside of occlusal surface 940 proximate locations where bicuspid teeth are received into material receiving portion 910, e.g., connections 930a and 930b. In another embodiment, handle 920 is coupled to the underside of occlusal surface 940 proximate locations where cuspid teeth are received into material receiving portion 910.

Handle 920 is also coupled to the underside of occlusal surface 940 proximate a location where incisor teeth are received into material receiving portion 910, e.g., connection 930c. By placing connection 930c beneath edges of incisors, torque upon removal of dental impression tray 900 with hardened impression material is reduced. In other words, by placing connection 930c beneath incisors, lateral force on the incisors is reduced.

As shown in FIG. 9B, handle 920 is coupled to material receiving portion 910 such that impression material distortion forces are distributed away from anterior portion 950 of dental impression tray 900 upon removal of dental impression tray 900 and at least partially solidified impression material from a plurality of teeth. It should be appreciated that anterior portion 950 is an example anterior portion, and is shown as a dotted line indicating a general area from which impression material distortion forces are directed from. Handle 920 also includes connector 952 coupling handle 920 to material receiving portion 910 proximate a location where incisor teeth are received into material receiving portion 910, e.g., connection 930c.

FIG. 10A is a top-down view of a dental impression tray 1000 including an anterior torque reducing handle 1020, in accordance with a third embodiment of the present invention. Dental impression tray 1000 includes material receiving portion 1010 including a trough configured to receive impression material used in forming a dental impression of a plurality of teeth. Impression material receiving portion includes outer wall 1044, inner wall 1042, occlusal surface 1040, and open rear edge 1046. Outer wall 1044, inner wall 1042 and contoured occlusal surface 1040 are formed to create the trough for receiving impression used in forming a dental impression of a plurality of teeth, e.g., trough 400 of FIG. 4. It should be appreciated that dental impression tray 1000 can receive any type of dental impression material, such as alginate for use in making dental impressions, and other types of treatment materials used in dental procedures, including without limitation fluoride treatment and gingivitis treatment.

Dental impression tray 1000 also includes an anterior torque reducing handle 1020 coupled to material receiving portion 1010. Anterior torque reducing handle 1020 is configured for distributing impression material distortion forces away from an anterior portion of dental impression tray 1000 upon removal of dental impression tray 1000 and at least partially solidified impression material from a plurality of teeth. Handle 1020 is coupled to the underside of occlusal surface 1040 of material receiving portion 1010 opposite the trough, illustrated in FIG. 10B as outer occlusal surface 1041.

Connection 1030 illustrates a location at which handle 1020 is coupled to the underside of occlusal surface 1040. Connection 1030 is shown in dotted lines as it represents a hidden view of a location at which handle 1020 is connected to impression receiving material portion 1010. Handle 1020 is coupled to the underside of occlusal surface 1040 such that handle 1020 is not coupled to a wall, e.g., inner wall 1042 or outer wall 1044, of material receiving portion 1010. In one embodiment, handle 1020 is coupled to the underside of occlusal surface 1040 proximate a location where incisor teeth are received into material receiving portion 1010, e.g., connection 1030. By placing connection 1030 beneath edges of incisors, torque upon removal of dental impression tray 1000 with hardened impression material is reduced. In other words, by placing connection 1030 beneath incisors, lateral force on the incisors is reduced.

As shown in FIG. 10B, handle 1020 is coupled to material receiving portion 1010 such that impression material distortion forces are distributed away from anterior portion 1050 of dental impression tray 1000 upon removal of dental impression tray 1000 and at least partially solidified impression material from a plurality of teeth. It should be appreciated that anterior portion 1050 is an example anterior portion, and is shown as a dotted line indicating a general area from which impression material distortion forces are directed from.

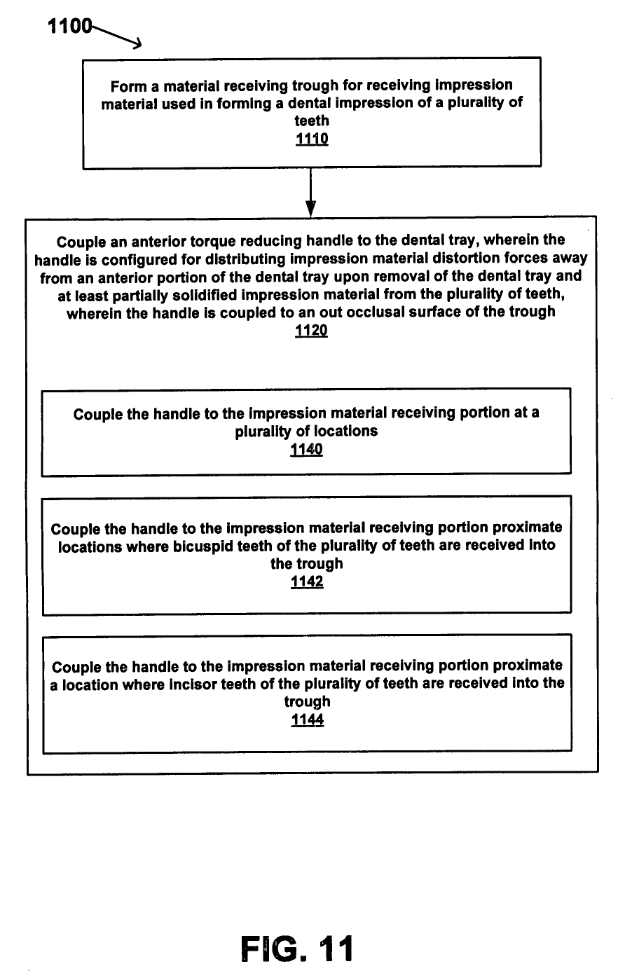

FIG. 11 is a flow chart illustrating an example process 1100 for fabricating a dental impression tray including an anterior torque reducing handle, in accordance with one embodiment of the present invention. In one embodiment, process 1100 is carried out by an impression tray fabrication system. For purposes of clarity and brevity, embodiments of process 1100 are described with reference to dental impression tray 800 of FIGS. 8A and 8B. However, it should be appreciated that process 1100 may be more generally applied to other dental impression trays, such as dental impression tray 300 of FIGS. 2, 3 and 4, dental impression tray 900 of FIGS. 9A and 9B, dental impression tray 1000 of FIGS. 10A and 10B, and dental impression tray 1300 of FIG. 13.

At step 1110 of process 1100, material receiving portion 810 of dental impression tray 800 including a trough for receiving impression material used in forming a dental impression of a plurality of teeth is formed. In one embodiment, the dental impression tray is formed from plastic or other polymer. In another embodiment, the dental impression tray is formed from a metallic substance.

At step 1120, anterior torque reducing handle 820 is coupled to material receiving portion 810, wherein handle 820 is configured for distributing impression material distortion forces away from an anterior portion of dental impression tray 800 upon removal of dental impression tray 800 and at least partially solidified impression material from a plurality of teeth. Anterior torque reducing handle 820 is coupled to outer occlusal surface 841 of material receiving portion 810 opposite the trough.

In one embodiment, as shown at step 1140, anterior torque reducing handle 820 is coupled to material receiving portion 810 at a plurality of locations. In one embodiment, as shown at step 1142, anterior torque reducing handle 820 is coupled to occlusal surface 840 of material receiving portion 810 proximate locations where bicuspid teeth of the plurality of teeth are received into material receiving portion 810.

In one embodiment, as shown at step 1144, the anterior torque reducing handle is coupled to an occlusal surface of the impression material receiving portion proximate a location where incisor teeth of the plurality of teeth are received into the impression material receiving portion. In one embodiment, step 1144 follows step 1142, such that the anterior torque reducing handle is coupled to the impression material receiving portion in three locations, e.g., as shown in FIGS. 9A and 9B. In another embodiment, step 1144 is performed independent of step 1140 and step 1142, such that the anterior torque reducing handle is coupled to the impression material receiving portion in one location, e.g., as shown in FIGS. 10A and 10B.

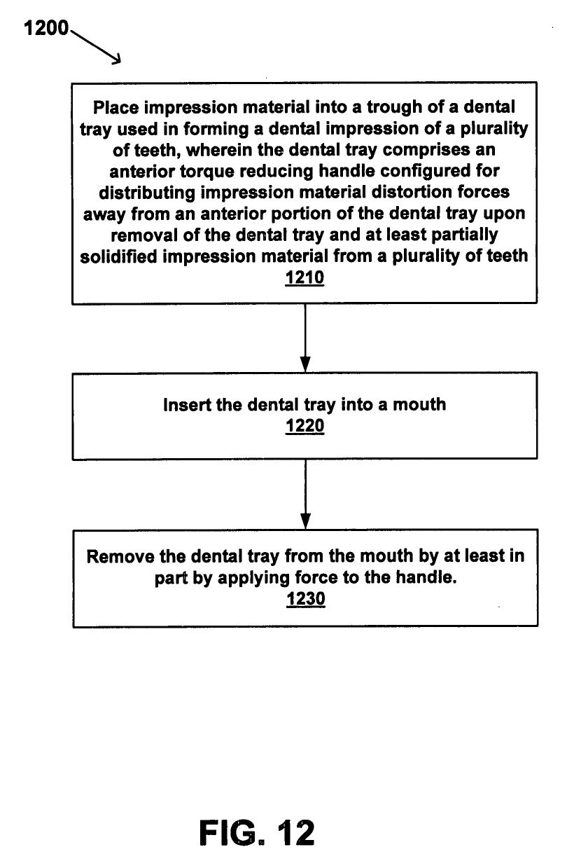

FIG. 12 is a flow chart illustrating an example process 1200 for reducing incisor distortion of a dental impression, in accordance with one embodiment of the present invention. Process 1200 is carried out by an impression taker, such as a dentist, orthodontist or other dental professional. For purposes of clarity and brevity, embodiments of process 1200 are described with reference to dental impression tray 800 of FIGS. 8A and 8B. However, it should be appreciated that process 1100 may be more generally applied to other dental impression trays, such as dental impression tray 300 of FIGS. 2, 3 and 4, dental impression tray 900 of FIGS. 9A and 9B, dental impression tray 1000 of FIGS. 10A and 10B, and dental impression tray 1300 of FIG. 13.

At step 1210, impression material is placed into a trough of dental impression tray 800 used in forming a dental impression of a plurality of teeth, in which dental impression tray 800 includes anterior torque reducing handle 820 configured for distributing impression material distortion forces away from an anterior portion of dental impression tray 800 upon removal of dental impression tray 800 and at least partially solidified impression material from a plurality of teeth.

At step 1220, dental impression tray 800 is placed into a patient's mouth. In one embodiment, as shown at step 1230, dental impression tray 800 is removed from the patient's mouth by at least in part applying force to anterior torque reducing handle 820.

While the methods of embodiments illustrated in processes 1100 and 1200 show specific sequences and quantity of steps, the present invention is suitable to alternative embodiments. For example, embodiments of the present invention do not require all the steps provided for in the processes. Furthermore, additional steps can be added to the steps presented in the described embodiments. Likewise, the sequences of steps can be modified depending upon the application.

Embodiments of the present invention provide a dental impression tray including an anterior torque reducing handle for reducing anterior thinning. By distributing impression material distortion forces away from an anterior portion of the dental impression tray, impressions of teeth in the anterior portion are improved. In various embodiments, by providing a plurality of connections between the anterior torque reducing handle and the impression material receiving portion, bilateral forced is used in removing the dental impression tray, reducing anterior torque. In other embodiments, by connecting the anterior torque reducing handle to the impression material receiving portion in at least one location not coupled to a wall of the impression material receiving portion, impression material distortion forces causing separation between the hardened impression material and the wall are further reduced.

Dental Impression Tray with Integrated Instructional Information

FIG. 13 is a top-down view of a dental impression tray 1300 including integrated instructional information, in accordance with an embodiment of the present invention. Dental impression tray 1300 includes a trough configured to receive impression material used in forming a dental impression of a plurality of teeth. Impression material receiving portion includes an outer wall, an inner wall, and an occlusal surface formed to create the trough, e.g., trough 400 of FIG. 4. It should be appreciated that dental impression tray 1300 operates in a similar manner to and can be combined in various embodiments with dental impression tray 300 of FIGS. 2, 3 and 4, dental impression tray 800 of FIGS. 8A and 8B, dental impression tray 900 of FIGS. 9A and 9B, and dental impression tray 1000 of FIGS. 10A and 10B.

It should be appreciated that dental impression tray 1300 can receive any type of dental impression material, such as alginate for use in making dental impressions. In one embodiment, as described below, dental impression tray is configured to receive chromatic changing impression material, such as chromatic changing alginate. Chromatic changing impression material is configured to change color as the impression material hardens. As the color changes, different colors indicate different actions that should be performed by the impression taker.

For example, in one embodiment, the impression material initially is purple in color just after mixing with water. As the impression material hardens, it turns bright pink, indicating that the impression material is ready for loading into the impression tray. As hardening continues, pink indicates that the loaded impression tray should be inserted into a patient's mouth over their dentition. A dull, washed out pink indicates that the impression material has hardened such that it should not be inserted into a patient's mouth if the impression material has not already been inserted. Finally, white indicates that the impression material has hardened and can be removed from the patient's mouth after the passing of a predetermined amount of time, e.g., forty-five or ninety seconds.

Dental impression tray 1300 includes integrated instructional information. The instructional information is configured to provide instruction on the timing of placement of dental impression tray 1300 into a patient's mouth when impression material is placed within the trough. In one embodiment, the instructional information includes chromatic information 1310. Chromatic information 1310 includes a color substantially matching an impression material color indicating that chromatic changing impression material is ready for insertion over the plurality of teeth. For example, consider where chromatic information 1310 is bright pink such that when the chromatic changing impression material looks substantially bright pink, the impression material is ready for loading into impression tray 1310. It should be appreciated that the color of chromatic information 1310 need not be identical to the color of the chromatic changing impression material. Rather, the color of chromatic information 1310 should be similar enough to the color of chromatic changing impression material to indicate to an impression taker that the impression material is ready for loading into the trough.

In various embodiments, dental impression tray 1300 includes additional integrated instructional information. In one embodiment, this instructional information includes chromatic information 1320. For example, chromatic information 1320 may include a color substantially matching an impression material color indicating that chromatic changing impression material has solidified beyond the point as to which the impression material is usable to form the dental impression. In one embodiment, this instructional information includes chromatic information 1330. For example, chromatic information 1330 includes a color substantially matching an impression material color indicating that chromatic changing impression material is ready for removal from a patient's mouth. In various embodiments, the instructional information also includes textual instructions 1312, 1322 and 1332 for use in conjunction with chromatic information 1310, 1320 and 1330, respectively.

Various embodiments of the present invention described herein provide a dental impression tray including a contoured occlusal surface, a dental impression tray including an anterior torque reducing handle, and a dental impression tray including integrated instructional information. It should be appreciated that the described embodiments can be combined to include any combination of the described features. For instance, dental impression tray 300 of FIGS. 2, 3 and 4 can include additional features such as an anterior torque reducing handle as described in dental impression tray 800 of FIGS. 8A and 8B, dental impression tray 900 of FIGS. 9A and 9B, and dental impression tray 1000 of FIGS. 10A and 10B or integrated instructional information as described in dental impression tray 1300 of FIG. 13. Moreover, it should be appreciated that embodiments of the present invention are not limited to the described embodiments, but rather to combinations thereof, as will be easily understood by one of skill in the art.

Embodiments of the present invention, a dental impression tray and a method for reducing potential show through of a dental impression, are thus described. While the invention is described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the description of embodiments of the present invention, numerous specific details are set forth in order to provide a thorough understanding of the present invention. However, it will be recognized by one of ordinary skill in the art that embodiments of the present invention may be practiced without these specific details. In other instances, well known methods, procedures, components, and circuits have not been described in detail as not to unnecessarily obscure aspects of embodiments of the present invention.

What is claimed:

1. A dental impression tray comprising:
a trough for receiving impression material used in forming a dental impression of a plurality of teeth; and
a contoured occlusal surface within said trough for reducing potential surface area contact with a tooth of said plurality of teeth.

2. The dental impression tray of claim 1 wherein said contoured occlusal surface comprises positive contouring.

3. The dental impression tray of claim 1 wherein said contoured occlusal surface comprises a plurality of positive contoured features.

4. The dental impression tray of claim 3 wherein said plurality of positive contoured features protrude upward from said contoured occlusal surface and into said trough.

5. The dental impression tray of claim 3 wherein said plurality of positive contoured features comprises substantially hemispherical bumps protruding upward from said contoured occlusal surface and into said trough.

6. The dental impression tray of claim 3 wherein said plurality of positive contoured features are arranged in a pattern on said contoured occlusal surface for reducing potential surface area contact with a tooth of said plurality of teeth.

7. The dental impression tray of claim 3 wherein said plurality of positive contoured features are arranged such that potential show through of a tooth of said plurality of teeth through said impression material is less than a predetermined show through threshold.

8. The dental impression tray of claim 7 wherein said predetermined show through threshold is not greater than one square millimeter.

9. The dental impression tray of claim 1 further comprising an anterior torque reducing handle coupled to the dental impression tray, wherein the handle is configured for distributing material distortion forces away from an anterior portion of the dental impression tray upon removal of the dental impression tray.

10. The dental impression tray of claim 1 further comprising chromatic instructional information integrated into the dental impression tray, the chromatic instructional information configured to provide instruction on timing of placement of the dental impression tray into a patient's mouth when impression material is placed within the trough.

11. The dental impression tray of claim 10 wherein the chromatic instructional information comprises a color substantially matching an impression material color indicating that the impression material is ready for insertion into a patient's mouth.

12. A method for reducing potential show through of a dental impression, said method comprising:
placing impression material into a trough of a dental impression tray used in forming a dental impression of a plurality of teeth, wherein said dental impression tray comprises a contoured occlusal surface within said trough for reducing potential surface area contact with a tooth of said plurality of teeth; and
inserting said dental impression tray into a mouth.

13. The method of claim 12 wherein said contoured occlusal surface comprises positive contouring.

14. The method of claim 12 wherein said contoured occlusal surface comprises a plurality of positive contoured features protruding upward from said contoured occlusal surface and into said trough.

15. A method for fabricating a dental impression tray, said method comprising:
forming a dental impression tray comprising a trough for, receiving impression material used in forming a dental impression of a plurality of teeth; and
forming positive contouring on an occlusal surface within said trough, said positive contouring for reducing potential surface area contact with a tooth of said plurality of teeth.

16. The method of claim 15 wherein said forming positive contouring on an occlusal surface within said trough comprises forming a plurality of positive contoured features on said occlusal surface.

17. The method of claim 16 wherein said plurality of positive contoured features protrude upward from said contoured occlusal surface and into said trough.

18. The method of claim 16 wherein said plurality of positive contoured features comprises substantially hemispherical bumps protruding upward from said contoured occlusal surface and into said trough.

19. The method of claim 15 wherein said plurality of positive contoured features are arranged in a pattern on said contoured occlusal surface for reducing potential surface area contact with a tooth of said plurality of teeth.

20. The method of claim 15 wherein said plurality of positive contoured features are arranged such that potential show through of a tooth of said plurality of teeth through said impression material is less than a predetermined show through threshold.
